(19) United States
(12) Patent Application Publication
(10) Pub. No.: US 2026/0260292 A1
(43) Pub. Date: Sep. 3, 2026

(54) AI-Enhanced Blockchain Smart Contract System for Cross-Border Payments and Real-Time Financial Settlement

(71) Applicant: FURONG BEI, SAN GABRIEL, CA (US)

(72) Inventor: FURONG BEI, SAN GABRIEL, CA (US)

(21) Appl. No.: 19/067,732

(22) Filed: Feb. 28, 2025

Related U.S. Application Data
(63) Continuation-in-part of application No. 19/051,584, filed on Feb. 12, 2025, now abandoned.
(63) Continuation-in-part of application No. 19/060,663, filed on Feb. 22, 2025.
(63) Continuation-in-part of application No. 19/064,689, filed on Feb. 27, 2025.
(63) Continuation-in-part of application No. 19/053,406, filed on Feb. 13, 2025, now abandoned.
(63) Continuation-in-part of application No. 19/056,745, filed on Feb. 19, 2025.
(63) Continuation-in-part of application No. 19/051,353, filed on Feb. 12, 2025, now abandoned.
(63) Continuation-in-part of application No. 19/053,450, filed on Feb. 14, 2025, now abandoned.
(63) Continuation-in-part of application No. 19/054,778, filed on Feb. 15, 2025, now abandoned.
(63) Continuation-in-part of application No. 19/059,110, filed on Feb. 20, 2025, now abandoned.
(60) Provisional application No. 63/759,784, filed on Feb. 18, 2025.

(51) Int. Cl. G06Q 40/04

(52) U.S. Cl. CPC G06Q 40/04

(57) ABSTRACT

This invention discloses a global sovereign financial infrastructure that replaces legacy systems like SWIFT and BIC. The architecture's core is the “Green ATMS. com Code,” a unique, blockchain-based identifier minted as a non-fungible token (NFT) for each entity. This code is paired with a BEI (Behavioral Economic Identity and Index) system to measure and tokenize behavior, enabling each person to operate as a sovereign banking terminal.

Upon issuance, each Green Code programmatically triggers the deployment of containerized financial services to a dedicated subdomain. Transactions are managed by the novel BESIGN protocol, which features reversible, consent-based clearing logic. A federated AI risk engine provides real-time scoring to automate compliance and dynamically adjust fees. The entire system is governed by a multi-signature/DAO framework with post-quantum security, creating a verifiable, interoperable architecture for global economic mobility.

### CROSS-REFERENCE TO RELATED APPLICATIONS

This application claims priority to and incorporates by reference in their entirety the following U.S. Patent Applications and U.S. Patent Application Publications: U.S. patent application Ser. Nos. 19/094,730; 19/074,352; 19/078,527; 19/074,326; . 19/190,647; U.S. Pub. No. US20250209465A1; U.S. Pub. No. US20250227086A1; U.S. Pub. No. US20250225583A1; and U.S. Pub. No. US20250217894A1. This application further incorporates by reference the BEI ecosystem, which comprises over 350 interrelated inventions covering identity and verification (e.g., BEIID, BEIDID); tokenization and issuance (e.g., BEIMINT, BEINFT, BEITOKEN); clearing and settlement (e.g., BEISX, BEICX, BEICBC, BEIDEFI); decentralized governance (DAO-based modules); and reserve-grade monetary instruments (e.g., BEIUSD, BEIRESERVER). This ecosystem is supported by a portfolio of strategic domain assets including GREENATMS.com, BEIBANKING.com, BEIBIC.com, BEICBC.com, and BEIDEFI.com.

### FIELD OF THE INVENTION

The present invention relates to programmable financial identity architecture, sovereign currency infrastructure, decentralized clearing and auditing systems, and domain-based identity governance. The invention applies across central bank digital currencies (CBDCs), decentralized finance (DeFi), clearing networks, central banks, DAO governance, and sovereign asset tokenization systems.

### BACKGROUND OF THE INVENTION

Legacy financial systems, such as those reliant on SWIFT and BIC codes, lack real-time programmability, sovereign adaptability, and privacy-preserving governance. Conventional cross-border payment systems often depend on multiple correspondent banks, which results in lengthy clearing cycles and high transaction fees. The emergence of quantum computing capabilities also presents a future threat to the classical cryptography that underpins existing financial platforms. A new paradigm is required to address these inefficiencies and security vulnerabilities, enabling each person and organization to engage directly in tokenized, traceable, and self-sovereign financial operations.

### SUMMARY OF THE INVENTION

This invention serves as the constitutional charter for a sovereign, programmable, and decentralized global financial system. It enshrines the Green ATMS.com Code not only as a protocol, but as a planetary anchor—leveraging DNSSEC to bind subdomain-level identities with immutable cryptographic integrity, and integrating behavioral identity credentials through BEIDID smart contracts. Paired with the BEI (Behavioral Economic Identity and Index) system, this invention ensures that every behavior, identity, and action can be measured, valued, tokenized, and reconciled across a borderless economic network. Unlike conventional DeFi frameworks, this invention integrates sovereign identity, behavior-indexed credit, domain-based service deployment, and real-time compliance mechanisms into a unified architecture, replacing legacy systems like SWIFT and BIC with self-sovereign, real-time, consent-based economic mobility for every person on Earth.

### BRIEF DESCRIPTION OF THE DRAWINGS

FIG. 1: Illustrates the architecture for Green Code generation and identity minting.

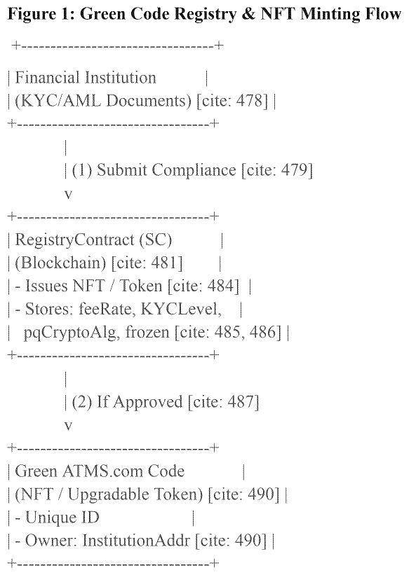

FIG. 2: Shows the institutional subdomain container deployment structure.

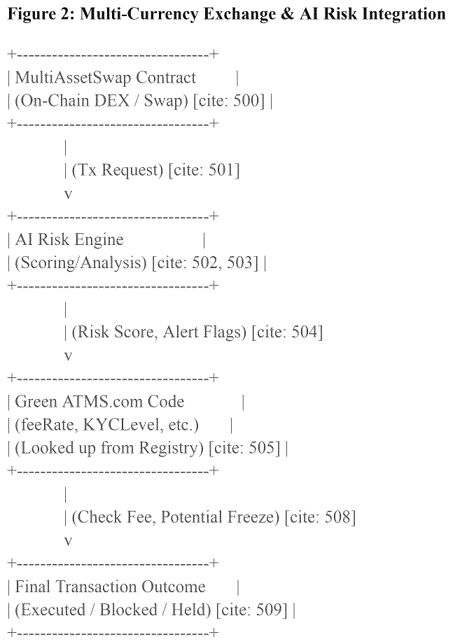

FIG. 3: Depicts the BESIGN Clearing Protocol flow, including rollback and freeze triggers.

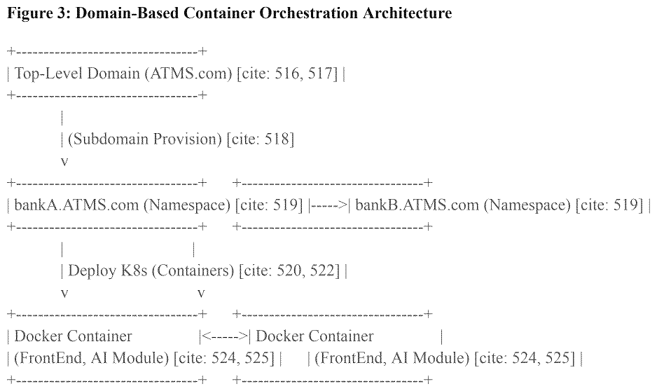

FIG. 4: Presents the integration of the AI-Driven Risk Engine with the ZK Audit Module.

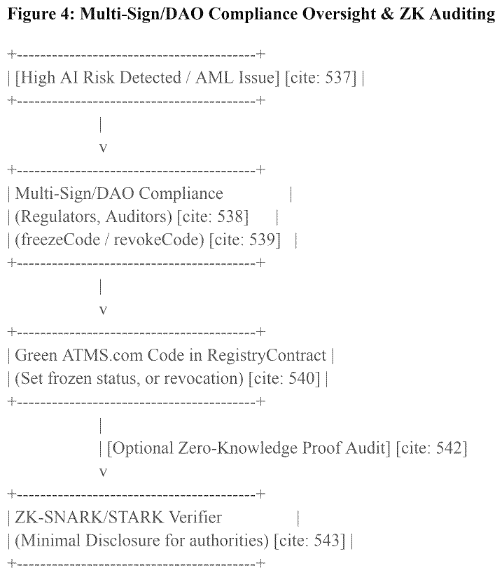

FIG. 5: Details the upgradable cryptographic container for Post-Quantum Security (PQC) upgrades.

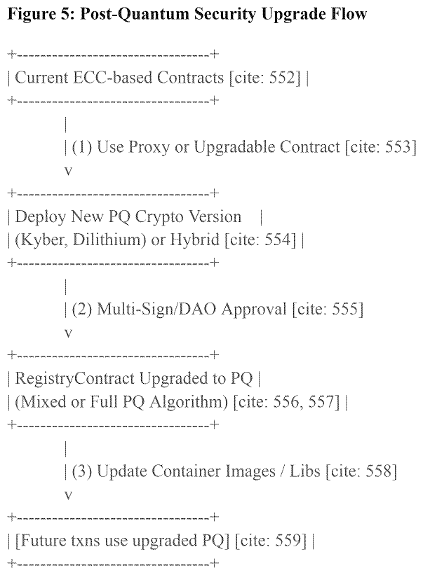

### DETAILED DESCRIPTION OF THE INVENTION

The invention comprises a multi-layered, integrated financial architecture built upon core functional modules:

(1) Identity and Verification Layer (BEIID/BEIDID): The system's foundation is a decentralized, blockchain-anchored identity registration layer. Each entity is issued a unique “Green ATMS.com Code,” minted on-chain as a programmable, non-fungible cryptographic object. This Code serves as the entity's sovereign financial identity. It integrates with BEIDID smart contracts to link to behavioral identity credentials and is anchored to a secure, DNSSEC-enabled subdomain.
(2) Tokenization and Issuance Layer (BEIMINT/BEINFT/BEITOKEN): The architecture includes a tokenization layer that integrates with BEIMINT and related protocols. This allows for the minting of various cryptographic instruments based on behavior, including reputation tokens and other value-linked assets.

(3) Clearing and Settlement Layer (BEISIGN, BEICX, BEISX, BEICBC, BEIDEFI): The system replaces traditional switch codes with the BEISIGN protocol, which provides reversible transaction logic based on multi-party consent. This layer facilitates multi-currency clearing and settlement across both traditional and decentralized financial ecosystems, supported by modules such as BEICBC for central bank currencies and BEIDEFI for DeFi protocols.

(4) Federated AI Engine for Risk Scoring and Compliance: A robust AI risk engine analyzes real-time transaction data to detect anomalies and potential compliance violations. The engine can use federated learning, allowing institutions to share model parameters without revealing raw transaction data. The resulting risk score can trigger automated actions.

(5) Decentralized Governance Layer (DAObased Modules): The system is overseen by a DAO-based governance layer. Authorized participants can vote to freeze or revoke Green Codes based on risk alerts or compliance failures. The governance structure can also authorize zero-knowledge proof audits for privacy-preserving verification.

(6) Reserve-Grade Monetary Instruments (BEIUSD/BEIEUR/BEICNY): the architecture supports sovereign-level CBDC interoperability and other anchored currencies, facilitated through specific domains and gateways within the ecosystem.

The entire system is designed with an upgradable cryptographic framework, allowing for the integration of post-quantum algorithms to ensure future-proof security against emerging threats.

What is claimed is:

1. A method for managing a programmable, sovereign financial identity's lifecycle within a decentralized architecture, the method comprising the steps of:
a. registering, on a distributed ledger, a unique cryptographic identity for a financial entity, wherein said identity is minted as a non-fungible cryptographic object and its metadata includes embedded behavioral indices, regulatory attributes, and selectable cryptographic standards;
b. programmatically linking said cryptographic identity to a dedicated, resolvable network address within a hierarchical domain system, and, upon successful registration, automatically triggering a container orchestration platform to deploy a modular, identity-based financial service node at said network address;
c. processing financial transactions associated with said identity using a multi-party consent clearing protocol, wherein said protocol comprises a state rollback mechanism that can be triggered by a consensus of authorized participants;
d. analyzing, in real-time, data associated with said transactions using an artificial intelligence (AI) risk engine to generate a dynamic risk score; and
e. enabling a decentralized governance mechanism, wherein a plurality of authorized nodes can execute a vote to cryptographically alter the operational status of said cryptographic identity on the distributed ledger based on inputs from the AI risk engine or external compliance data.

2. A system for providing a decentralized, sovereign financial infrastructure, the system comprising:
a. one or more hardware processors;
b. a memory storing instructions that, when executed by the one or more hardware processors, configure the system to include:
i. a Registry Module deployed on a distributed ledger, configured to issue and manage unique, non-fungible cryptographic identities, each identity having metadata that includes compliance status and is programmatically bound to a unique network address within a domain-based namespace;
ii. a Container Deployment Module communicatively coupled to the Registry Module, configured to automatically deploy and manage the lifecycle of containerized financial service nodes in response to changes in the status of said cryptographic identities;
iii. a Clearing Protocol Module configured to process transactions using a reversible protocol that requires multi-party consent for final settlement and supports a governance-triggered state rollback;
iv. an AI Risk Engine Module configured to analyze transaction and behavioral data to generate a real-time risk score, wherein said score is used to dynamically modulate transaction parameters; and
v. a DAO Governance Module configured to allow a distributed network of authorized participants to vote on proposals that alter the state of cryptographic identities within the Registry Module.

3. A non-transitory computer-readable medium having instructions stored thereon, that when executed by one or more processors, cause a computing system to perform a method for decentralized asset settlement, the method comprising:
a. minting and issuing behavior-indexed transaction tokens that represent sovereign credits;
b. processing a transfer of said tokens between two or more cryptographic identities using a BESIGN protocol that implements a transaction rollback function, wherein said function is invocable by a multi-party consensus vote;
c. applying a dynamic surcharge to the transaction based on a real-time risk score generated by a federated AI learning model;
d. generating a zero-knowledge verifiable proof of the transaction and its resulting state change for auditable-yet-private record-keeping; and
e. facilitating a cryptographic upgrade path for the system's security protocols via a proxy smart contract architecture, enabling migration to post-quantum cryptographic standards.

4. The method of claim 1, wherein the registering step further comprises mapping legacy financial identifiers, including SWIFT or BIC codes, into the metadata of the cryptographic identity for backward compatibility.

5. The system of claim 2, wherein the non-fungible cryptographic identities are configured to be assigned at individual, institutional, and national levels to create a multi-layered identity framework.

6. The method of claim 1, wherein the network address is a subdomain anchored to a secure top-level domain, and wherein the linking step is secured using DNSSEC protocols.

7. The system of claim 2, wherein the containerized financial service nodes provide modular Application Programming Interfaces (APIs) for digital wallets, CBDC gateways, and third-party financial services.

8. The method of claim 1, wherein said behavioral indices are updated based on an entity's verifiable transaction history and governance participation, influencing their sovereign credit score.

9. The system of claim 2, wherein the AI Risk Engine Module utilizes a federated learning model, allowing multiple, independent nodes to collaboratively train a risk model without exposing their underlying private data.

10. The method of claim 1, wherein jurisdictional compliance rules are encoded as updatable parameters within the decentralized governance mechanism, allowing for dynamic adjustments based on regional regulations.

11. The system of claim 2, wherein the DAO Governance Module allows authorized regulatory bodies to access embedded audit logs via a role-based, zero-knowledge interface.

12. The method of claim 3, wherein the rollback function is triggered to reverse transactions in cases of verified fraud or upon the execution of a multilateral financial agreement's escape clause handled by a smart contract.

13. The system of claim 2, wherein the Container Deployment Module is configured to deploy nodes across a global network of sovereign DNS servers mapped to a portfolio of nationally-anchored and top-level domains.

14. The method of claim 1, wherein the method further comprises tokenizing intellectual property, including patent assets, using the cryptographic identity as the root of title for said tokenized assets.

15. The system of claim 2, wherein said system is designated as an Autonomous Transactional Monetary System (ATMS).

16. The method of claim 1, wherein the cryptographic identity serves as a root identifier for both digital and physical assets, enabling unified asset management.

17. The system of claim 2, wherein the Clearing Protocol Module is further configured to facilitate multi-currency swaps, with slippage tolerance dynamically adjusted based on the risk scores of the participating identities.

18. The method of claim 3, further comprising routing token issuance and clearance priorities based on a domain-driven network map, prioritizing transactions within sovereign-chartered zones.

19. The system of claim 2, wherein the cryptographic identities are interoperable with a BEIDID sovereign decentralized identity framework.

20. The method of claim 1, wherein every deployed financial service node is configured to operate as a self-sovereign bank node, enabling each entity to directly participate in the financial system.
